(19) United States
(12) Patent Application Publication
(10) Pub. No.: US 2017/0372334 A1
(43) Pub. Date: Dec. 28, 2017

(54) AGENT-BASED MONITORING OF AN APPLICATION MANAGEMENT SYSTEM

(71) Applicant: AppDynamics LLC, San Francisco, CA (US)

(72) Inventors: Hatim Shafique, San Francisco, CA (US); Arpit Patel, San Francisco, CA (US); Vikash Kumar, San Francisco, CA (US)

(21) Appl. No.: 15/700,675

(22) Filed: Sep. 11, 2017

Related U.S. Application Data
(63) Continuation-in-part of application No. 14/609,308, filed on Jan. 29, 2015.

(51) Int. Cl. G06Q 30/02; G06F 9/455

(52) U.S. Cl. CPC G06Q 30/0201; G06F 9/45508

(57) ABSTRACT

In one embodiment, one or more agents monitor the usage of an application management system by one or more users associated with an entity, the one or more agents executing on one or more servers that implement the application management system. An adoption score for the entity is generated based on collected usage data and used to form a combined score for the entity that can be used, e.g., for resource allocation in the application management system.

### RELATED APPLICATIONS

This application is a continuation-in-part of, and claims priority to, U.S. application Ser. No. 14/609,308, entitled “CUSTOMER HEALTH TRACKING SYSTEM BASED ON MACHINE DATA AND HUMAN DATA,” by Shafique et al., filed on Jan. 29, 2015, the contents of which are hereby incorporated by reference.

### BACKGROUND OF THE INVENTION

As the Internet continues to expand, the number of online service and applications will continue to grow. Entities such as schools, government agencies, businesses, etc., that provide these services and applications may wish to employ the use of an application management system that monitors the deployed services and applications. Thus, as the use of online services and applications continues to grow, so too will the use of management systems that oversee these services and applications.

Resource planning for an application management system is a key requirement for keeping up with the increasing demands of the entities accessing the management system. However, simple metrics, such as a count of logins to the application management system, may not tell the whole story in terms of usage. For example, users associated with one entity may regularly log into the application management system, but suddenly stop using the system for any number of reasons. Predicting when such users are likely to discontinue use of the service can play an important role in scaling the application management system and ensuring that sufficient resources are always available.

### SUMMARY OF THE CLAIMED INVENTION

In various embodiments, one or more agents monitor usage of an application management system by one or more users associated with an entity, the one or more agents executing on one or more servers that implement the application management system. Usage data is collected regarding the monitored usage from the one or more agents. An adoption score for the entity is generated based on the collected usage data. One or more subjective assessment scores associated with the entity is received from a user interface and a combined score for the entity is generated based on the generated adoption score and the one or more subjective assessment scores. The combined score is then provided for presentation by the user interface.

### BRIEF DESCRIPTION OF THE DRAWINGS

FIG. 1 is a system for monitoring usage of a service.

FIG. 2 is a block diagram of a controller.

FIG. 3 is a method for monitoring service usage.

FIG. 4 is a method for determining adoption level.

FIG. 5 is a method for calculating usage points.

FIG. 6 is a block diagram of a system for implementing the present technology.

### DETAILED DESCRIPTION

The present technology provides a system that allows for better resource allocation in a

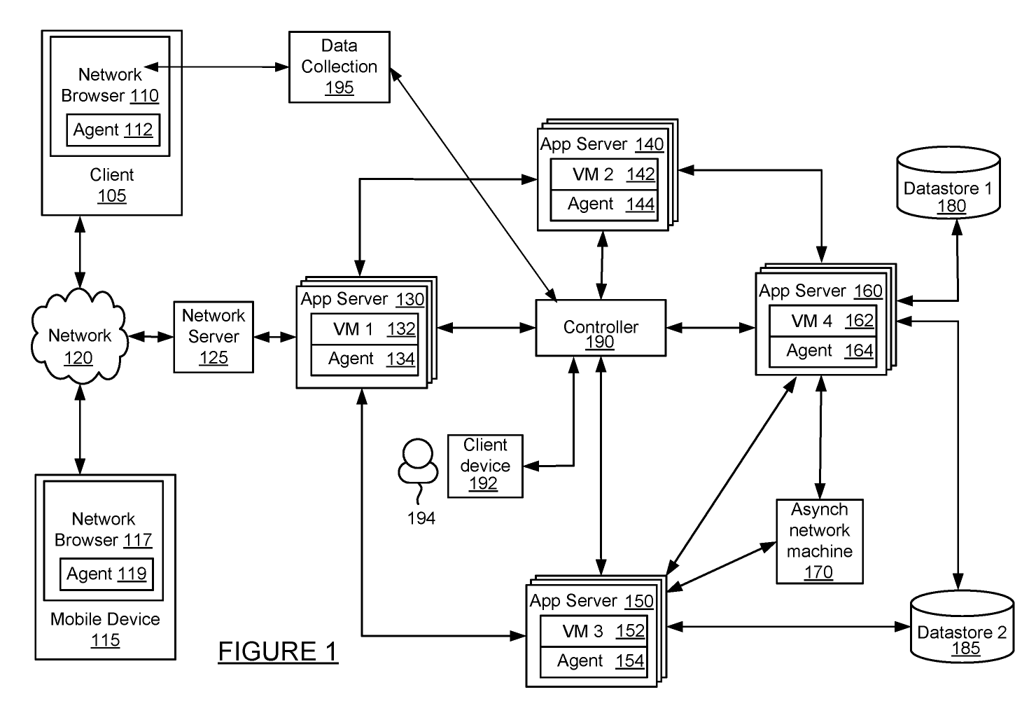

FIG. 1 is a block diagram of a system for monitoring usage of a service, such as an application service and/or an application management service that oversees an online service. System 100 of FIG. 1 includes client device 105 and 192, mobile device 115, network 120, network server 125, application servers 130, 140, 150 and 160, asynchronous network machine 170, data stores 180 and 185, and controller 190.

Client device 105 may include network browser 110 and be implemented as a computing device, such as for example a laptop, desktop, workstation, or some other computing device. Network browser 110 may be a client application for viewing content provided by an application server, such as application server 130 via network server 125 over network 120. Mobile device 115 is connected to network 120 and may be implemented as a portable device suitable for receiving content over a network, such as for example a mobile phone, smart phone, tablet computer or other portable device. Both client device 105 and mobile device 115 may include hardware and/or software configured to access a web service provided by network server 125.

Network 120 may facilitate communication of data between different servers, devices and machines. The network may be implemented as a private network, public network, intranet, the Internet, a Wi-Fi network, cellular network, or a combination of these networks.

Network server 125 is connected to network 120 and may receive and process requests received over network 120. Network server 125 may be implemented as one or more servers implementing a network service. When network 120 is the Internet, network server 125 may be implemented as a web server. Network server 125 and application server 130 may be implemented on separate or the same server or machine.

Application server 130 communicates with network server 125, application servers 140 and 150, controller 190. Application server 130 may also communicate with other machines and devices (not illustrated in FIG. 1). Application server 130 may host an application or portions of a distributed application and include a virtual machine 132, agent 134, and other software modules. Application server 130 may be implemented as one server or multiple servers as illustrated in FIG. 1, and may implement both an application server and network server on a single machine.

Application server 130 may include applications in one or more of several platforms. For example, application server 130 may include a Java application, .NET application, PHP application, C++ application, or other application. Different platforms are discussed below for purposes of example only.

Virtual machine 132 may be implemented by code running on one or more application servers. The code may implement computer programs, modules and data structures to implement, for example, a virtual machine mode for executing programs and applications. In some embodiments, more than one virtual machine 132 may execute on an application server 130. A virtual machine may be implemented as a Java Virtual Machine (JVM). Virtual machine 132 may perform all or a portion of a business transaction performed by application servers comprising system 100. A virtual machine may be considered one of several services that implement a web service.

Virtual machine 132 may be instrumented using byte code insertion, or byte code instrumentation, to modify the object code of the virtual machine. The instrumented object code may include code used to detect calls received by virtual machine 132, calls sent by virtual machine 132, and communicate with agent 134 during execution of an application on virtual machine 132. Alternatively, other code may be byte code instrumented, such as code comprising an application which executes within virtual machine 132 or an application which may be executed on application server 130 and outside virtual machine 132.

In embodiments, application server 130 may include software other than virtual machines, such as for example one or more programs and/or modules that processes AJAX requests.

Agent 134 on application server 130 may be installed on application server 130 by instrumentation of object code, downloading the application to the server, or in some other manner. Agent 134 may be executed to monitor application server 130, monitor virtual machine 132, and communicate with byte instrumented code on application server 130, virtual machine 132 or another application or program on application server 130. Agent 134 may detect operations such as receiving calls and sending requests by application server 130 and virtual machine 132. Agent 134 may receive data from instrumented code of the virtual machine 132, process the data and transmit the data to controller 190. Agent 134 may perform other operations related to monitoring virtual machine 132 and application server 130 as discussed herein. For example, agent 134 may identify other applications, share business transaction data, aggregate detected runtime data, and other operations.

Agent 134 may be a Java agent, .NET agent, PHP agent, or some other type of agent, for example based on the platform which the agent is installed on.

Each of application servers 140, 150 and 160 may include an application and an agent. Each application may run on the corresponding application server or a virtual machine. Each of virtual machines 142, 152 and 162 on application servers 140-160 may operate similarly to virtual machine 132 and host one or more applications which perform at least a portion of a distributed business transaction. Agents 144, 154 and 164 may monitor the virtual machines 142-162 or other software processing requests, collect and process data at runtime of the virtual machines, and communicate with controller 190. The virtual machines 132, 142, 152 and 162 may communicate with each other as part of performing a distributed transaction. In particular each virtual machine may call any application or method of another virtual machine.

Asynchronous network machine 170 may engage in asynchronous communications with one or more application servers, such as application server 150 and 160. For example, application server 150 may transmit several calls or messages to an asynchronous network machine. Rather than communicate back to application server 150, the asynchronous network machine may process the messages and eventually provide a response, such as a processed message, to application server 160. Because there is no return message from the asynchronous network machine to application server 150, the communications between them are asynchronous.

Data stores 180 and 185 may each be accessed by application servers such as application server 150. Data store 185 may also be accessed by application server 150. Each of data stores 180 and 185 may store data, process data, and return queries received from an application server. Each of data stores 180 and 185 may or may not include an agent.

Controller 190 may control and manage monitoring of business transactions distributed over application servers 130-160. Controller 190 may receive runtime data from each of agents 134-164, associate portions of business transaction data, communicate with agents to configure collection of runtime data, and provide performance data and reporting through an interface. The interface may be viewed as a web-based interface viewable by mobile device 115, client device 105, or some other device. In some embodiments, a client device 192 may directly communicate with controller 190 to view an interface for monitoring data.

Controller 190 may install an agent into one or more virtual machines and/or application servers 130. Controller 190 may receive correlation configuration data, such as an object, a method, or class identifier, from a user through client device 192.

Controller 190 may collect and monitor customer usage data collected by agents on customer application servers and analyze the data. The controller may report the analyzed data via one or more interfaces, including but not limited to a dashboard interface and one or more reports.

Data collection server 195 may communicate with client 105, 115 (not shown in FIG. 1), and controller 190, as well as other machines in the system of FIG. 1. Data collection server 195 may receive data associated with monitoring a client request at client 105 (or mobile device 115) and may store and aggregate the data. The stored and/or aggregated data may be provided to controller 190 for reporting to a user.

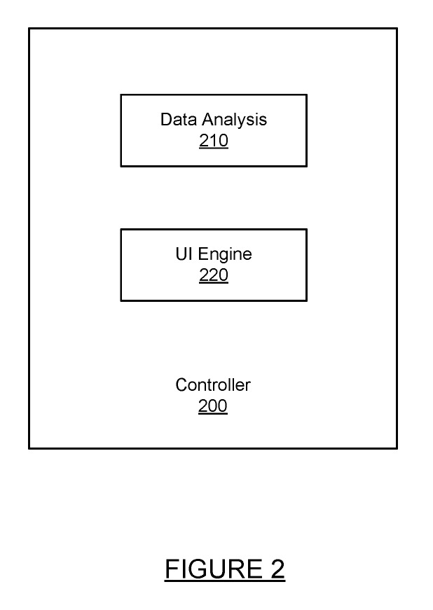

FIG. 2 is a block diagram of a controller. The controller 200 of FIG. 2 may provide more detail for controller 190 of the system of FIG. 1. Controller 200 includes data analysis module 210 and user interface engine 220. Data analysis module 210 may receive data from multiple sources. The sources may include one or more agents in the system of FIG. 1. In particular, customer usage data may be received from agents executing on different application servers. Usage data may also be received from user requests made to the controller, such as for example a login request(s) made by one or more users associated with an entity. In addition to usage data, data analysis module 210 may receive information from websites, such as LinkedIn, that may include user data on the users logging into the system.

Data analysis module 210 may also receive subjective assessment data regarding the usage via a user interface. In general, such subjective assessment data may include indications of various factors that can affect the resource consumption of the service (e.g., the application management system) by users associated with a given entity. Notably, the entity may utilize the application management system to monitor one or more services or applications associated with the entity. Example subjective assessments may include, as detailed below, a CRM rating and/or technology rating for the entity or user(s) associated with the entity. Data analysis to 10 may, upon receiving the data, generate data to be provided through a dashboard or report for use by an administrator.

UI engine 220 may provide one or more interfaces to a user. The interfaces may be provided to an administrator through a network-based content page, such as a webpage, through a desktop application, a mobile application, or through some other program interface. The user interface may provide the data and formatting for reviewing reports, providing a dashboard, and other interface viewing and activity.

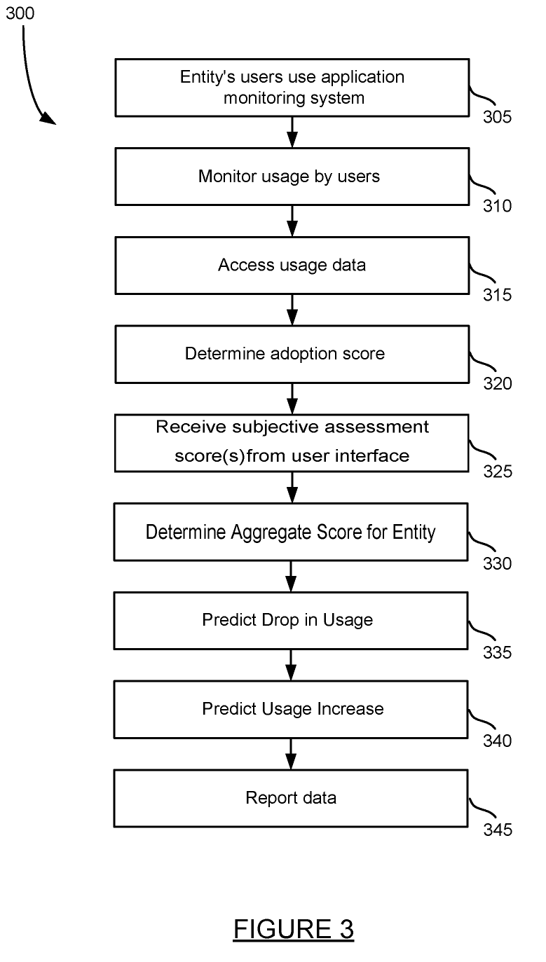

FIG. 3 is a method for monitoring service usage. First, a user associated with an entity (e.g., an employee of a business, a student at a school, etc.) may use an application monitoring system at step 305. Use of the system may include installing the system, configuring the system, or using the system to monitor web applications or other online services that implement, support, or are otherwise associated with the entity. For example, a business may utilize the application management system to review the functioning and use of the business' deployed mobile application.

Usage of the application management system may then be monitored at step 310. In some embodiments, the usage may be monitored through agents installed on application servers. For example, usage monitoring may include whether the user has downloaded the management application, installed and configured the management application, whether the customer is using features such as alerts and a dashboard, and activities. Usage monitoring may also include keeping track of user service issues, such as tickets for technical assistance, which are requested and handled by the provider.

The usage data may be accessed at step 315. Accessing the data may include gathering the data, aggregating portions of the data, storing the data and accessing the data by a controller.

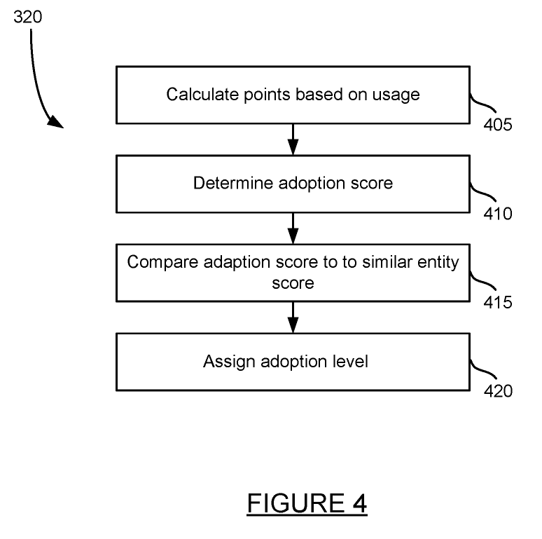

An adoption level for a particular customer may be determined at step 320. The adoption level may be determined based on data collected and/or generated (machine data) and administrator or user generated data. Determining an adoption level is discussed in more detail below with respect to the method of FIG. 4.

One or more subjective assessment scores may be received via a user interface, at step 325. In general, a subjective assessment score may be indicative of an expert's assessment of factors that may affect the entity's usage of the application management system. This information can be used to capture additional data points that may not be available via the management system itself and can, thus, enhance the overall assessment and prediction of resource utilization by the entity.

In on embodiment, an example subjective assessment score may be a technology score that represents the extent to which the technology has worked for the entity. For example, the technology score may be provided by a technical account manager or other expert familiar with the entity.

Another example subjective assessment score may be a CRM score that represents a subjective assessment of the relationship between the entity and the application management system. For example, even if a user associated with the entity is a heavy user of the application management system, if he or she lodges multiple complaints within a short amount of time, this may indicate that the usage is likely to drop off very soon.

At step 330, the system may determine an aggregate score for the entity based on the adoption score and the one or more subjective assessment scores. As usage of the application management system is not always a reliable indicator of the future usage (and, thus, resource consumption), combining the subjective assessment score(s) with the adoption score provides for a clearer picture of the usage state and can be used for more accurate predictions.

In some instances, the combined score may generated as a risk score. For example, a combined score may be determined in part from an externally generated adoption score, an internally generated adoption score, usage activity, and/or user support. For example, an adoption score from an external customer relationship management company may be in the range of 0 to 3, and 25 points may be provided per level within that range. The internally generated adoption score may have a range of 1 to 10, and may be used to generate points towards a risk value. The download activity may be scored as five points for down per download with a maximum of 20 points. The cases for customer support may be scored as a negative number of points per support case. Different levels of support cases may be scored differently, with more important or major support cases scored higher than less serious cases. The total points are then compared to ranges, and a corresponding risk label is assigned to the customer based on the range that includes the points total for the customer.

A drop in usage may be predicted at step 335. Based on the adoption score and/or the combined score that incorporates the subjective assessment score(s), the system may predict a drop in usage by the entity. Such a prediction can be used, e.g., to allocate resources dedicated to the entity to another entity, or the like.

A usage increase may be predicted at step 340. The usage increase may be predicted based on the adoption score or the combined score that is based in part on the subjective assessment score(s). The usage increase may be provided in terms of a percentage, a classification, or some other score. In turn, this prediction can be used to increase resource allocations by the system, accordingly.

In some embodiments, the usage increase may be based in part on a prediction that the entity will expand its use of the service (e.g., by using additional functions of the service, etc.). The expansion possibility may be determined for companies with an IT budget and without an IT budget. For companies with an IT budget, the percentage of an application program management budget may be determined per industry as the average of the deal size divided by the IT budget, with that amount multiplied by 100 times the percent APM budget by industry. The estimated APM spending may then be determined by the percentage APM budget divided by hundred times the IT budget. The expansion possibility may then be determined by comparing the estimated APM spending to the deal size. If a deal size is greater than an estimated APM spending, there is no possibility of expansion. Otherwise, there may be a possibility of expansion. The expansion amount may be determined by subtracting the deal size from the estimated APM spending. In other words, while simply trending analysis of the usage of the service may predict the future usage of the service, taking into account factors such as the entity's likelihood to access additional function of the service, add users, or the like, may provide for a better prediction.

Data may be reported at step 345. Data reporting may be done through any of a number of interfaces including a dashboard interface as well as one or more reports. Data may be reported in real time, based on agent reporting to a controller which provides the reported data.

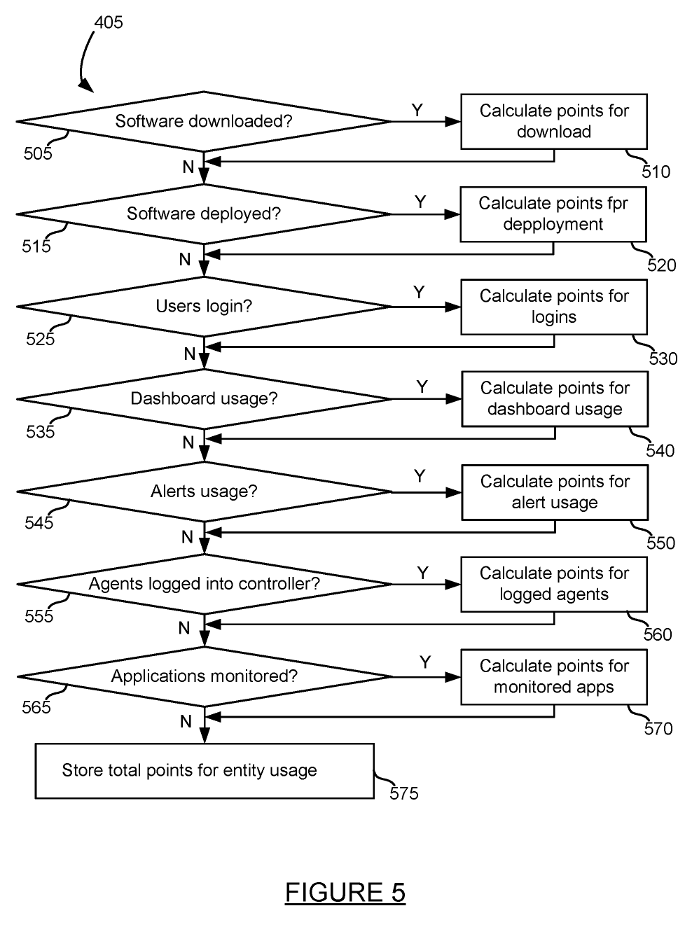

FIG. 4 is a method for determining an adoption level. The method of FIG. 4 provides more detail for step 320 of the method of FIG. 3. First, points are calculated based on usage at step 305. Points may be calculated based on a wide variety of usage types, including system configuration, user activity, and other events that can be monitored (e.g., by the agents). More detail for calculating points based on usage is discussed below with respect to the method of FIG. 5.

An adoption score is determined at step 310. The adoption score is determined as the total of the points calculated at step 305. The adoption score is then compared to adoption scores of similar entities at step 315. Entities may be similar if they are in the same industry, have a similar company size, have similar revenues, and other factors. An adoption level is then assigned at step 320. The adoption level may be assigned based on the adoption score determined at step 310 and a range of adoption scores for similar entities. The adoption level, for example, may have one of three levels consisting of “at risk,” “needs attention,” and “good.”

FIG. 5 is a method for calculating points based on usage. The method of FIG. 5 provides more detail for step 405 of the method of FIG. 4. First, a determination is made as to whether software has been downloaded by the user(s) associated with the entity at step 505. If software has not been downloaded, the method of FIG. 5 continues to step 515. If the software has been downloaded, points are calculated for the download at step 510 and the method continues to step 515.

A determination as to whether software has been deployed is made at step 515. If software has not been deployed, the method continues to step 525. If software has been deployed, points are calculated for the deployment at step 520 and the method continues to step 525.

A determination is made as a whether users have logged in at step 525. If users have not logged into the administrative interface or other portion of the service provided to the entity, the method continues to step 535. If users have logged in, points for logins are calculated at step 530. In some instances, a certain number of points are allotted for each login user, as well as each login within the last thirty days for a particular user.

A determination is made as to whether any dashboard usage has occurred at step 535. If the dashboard has not been used by the customer, the method of FIG. 5 continues to step 545. If the dashboard has been used, points are calculated for the dashboard usage at step 540. Points may be accumulated for each use or access of the dashboard as well as accessing different portions of the dashboard.

Next, a determination is made as to whether there is usage of alerts at step 545. If alerts are not used, the method of FIG. 5 continues to step 555. If alert usage is detected, points are calculated for the alert usage at step 550 and the method continues to step 555.

A determination is made as to whether any agents are logged into a controller for the customer at step 555. If no agents are logged into a controller, the method of FIG. 5 continues to step 565. If agents are logged into a controller, points for the logged-in agents are calculated at step 560 and the method continues to step 565. A determination is made as to whether any applications are being monitored at step 565. If no applications are monitored for the customer, the method continues to step 575. If applications are being monitored, points are calculated for the monitored applications at step 570 and the method continues to step 575.

Total points for customer usage is determined at step 575. The total points may be the summary of the points calculated at steps 510, 20, 530, 540, 550, 560, and 570. The total usage points may be stored for later use by the controller.

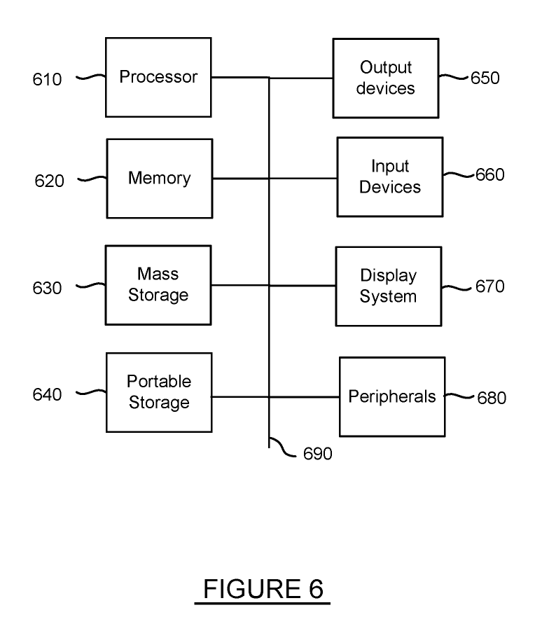

FIG. 6 is a block diagram of a computer system for implementing the present technology. System 600 of FIG. 6 may be implemented in the contexts of the likes of clients 105 and 192, network server 125, application servers 130-160, asynchronous server 170, and data stores 190-185. A system similar to that in FIG. 6 may be used to implement mobile device 115, but may include additional components such as an antenna, additional microphones, and other components typically found in mobile devices such as a smart phone or tablet computer.

The computing system 600 of FIG. 6 includes one or more processors 610 and memory 620. Main memory 620 stores, in part, instructions and data for execution by processor 610. Main memory 620 can store the executable code when in operation. The system 600 of FIG. 6 further includes a mass storage device 630, portable storage medium drive(s) 640, output devices 650, user input devices 660, a graphics display 670, and peripheral devices 680.

The components shown in FIG. 6 are depicted as being connected via a single bus 690. However, the components may be connected through one or more data transport means. For example, processor unit 610 and main memory 620 may be connected via a local microprocessor bus, and the mass storage device 630, peripheral device(s) 680, portable storage device 640, and display system 670 may be connected via one or more input/output (I/O) buses.

Mass storage device 630, which may be implemented with a magnetic disk drive or an optical disk drive, is a non-volatile storage device for storing data and instructions for use by processor unit 610. Mass storage device 630 can store the system software for implementing embodiments of the present invention for purposes of loading that software into main memory 610.

Portable storage device 640 operates in conjunction with a portable non-volatile storage medium, such as a floppy disk, compact disk or Digital video disc, to input and output data and code to and from the computer system 600 of FIG. 6. The system software for implementing embodiments of the present invention may be stored on such a portable medium and input to the computer system 600 via the portable storage device 640.

Input devices 660 provide a portion of a user interface. Input devices 660 may include an alpha-numeric keypad, such as a keyboard, for inputting alpha-numeric and other information, or a pointing device, such as a mouse, a trackball, stylus, or cursor direction keys. Additionally, the system 600 as shown in FIG. 6 includes output devices 650. Examples of suitable output devices include speakers, printers, network interfaces, and monitors.

Display system 670 may include a liquid crystal display (LCD) or other suitable display device. Display system 670 receives textual and graphical information, and processes the information for output to the display device.

Peripherals 680 may include any type of computer support device to add additional functionality to the computer system. For example, peripheral device(s) 1280 may include a modem or a router.

The components contained in the computer system 600 of FIG. 6 are those typically found in computer systems that may be suitable for use with embodiments of the present invention and are intended to represent a broad category of such computer components that are well known in the art. Thus, the computer system 600 of FIG. 6 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

When implementing a mobile device such as smart phone or tablet computer, the computer system 600 of FIG. 6 may include one or more antennas, radios, and other circuitry for communicating over wireless signals, such as for example communication using Wi-Fi, cellular, or other wireless signals.

While there have been shown and described illustrative embodiments that provide for assessing usage of a service, it is to be understood that various other adaptations and modifications may be made within the spirit and scope of the embodiments herein. For example, while certain embodiments are described herein with respect to certain types of networks in particular, the techniques are not limited as such and may be used with any computer network, generally, in other embodiments. Moreover, while specific technologies, protocols, and associated devices have been shown, such as Java, TCP, IP, and so on, other suitable technologies, protocols, and associated devices may be used in accordance with the techniques described above. In addition, while certain devices are shown, and with certain functionality being performed on certain devices, other suitable devices and process locations may be used, accordingly. That is, the embodiments have been shown and described herein with relation to specific network configurations (orientations, topologies, protocols, terminology, processing locations, etc.). However, the embodiments in their broader sense are not as limited, and may, in fact, be used with other types of networks, protocols, and configurations.

Moreover, while the present disclosure contains many other specifics, these should not be construed as limitations on the scope of any invention or of what may be claimed, but rather as descriptions of features that may be specific to particular embodiments of particular inventions. Certain features that are described in this document in the context of separate embodiments can also be implemented in combination in a single embodiment. Conversely, various features that are described in the context of a single embodiment can also be implemented in multiple embodiments separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

For instance, while certain aspects of the present disclosure are described in terms of being performed “by a server” or “by a controller”, those skilled in the art will appreciate that agents of the application intelligence platform (e.g., application agents, network agents, language agents, etc.) may be considered to be extensions of the server (or controller) operation, and as such, any process step performed “by a server” need not be limited to local processing on a specific server device, unless otherwise specifically noted as such.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method comprising:
monitoring, by one or more agents, usage of an application management system by one or more users associated with an entity, the one or more agents executing on one or more servers that implement the application management system;
collecting usage data regarding the monitored usage from the one or more agents;
generating an adoption score for the entity based on the collected usage data;
receiving, from a user interface, one or more subjective assessment scores associated with the entity;
generating by the controller a combined score for the entity based on the generated adoption score and the one or more subjective assessment scores; and
providing the combined score for presentation by the user interface.

2. The method of claim 1, wherein the usage data is indicative of a number of logins to the application management system by the one or more users associated with the entity.

3. The method of claim 1, wherein the usage data is indicative of a number of times a dashboard associated with the application management system is accessed by the one or more users associated with the entity.

4. The method of claim 1, wherein generating the combined score includes:
determining a number of points to apply towards the combined score based on the usage data.

5. The method of claim 1, further comprising:
identifying a second entity based on a similarity score with the entity;
comparing the adoption score to an adoption score associated with the second entity.

6. The method of claim 1, wherein one of the one or more subjective assessment scores represents a technical success of the application management system.

7. The method of claim 1, further comprising:
predicting a drop in usage of the application management system by the one or more users associated with the entity.

8. The method of claim 1, further comprising:
predicting an increase in usage of the application management system by the one or more users associated with the entity.

9. A non-transitory computer readable storage medium having embodied thereon a program, the program being executable by a processor to perform a method comprising:
monitoring, by one or more agents, usage of an application management system by one or more users associated with an entity, the one or more agents executing on one or more servers that implement the application management system;
collecting usage data regarding the monitored usage from the one or more agents;
generating an adoption score for the entity based on the collected usage data;
receiving, from a user interface, one or more subjective assessment scores associated with the entity;
generating a combined score for the entity based on the generated adoption score and the one or more subjective assessment scores; and
providing the combined score for presentation by the user interface.

10. The non-transitory computer readable storage medium of claim 9, wherein the usage data is indicative of a number of logins to the application management system by the one or more users associated with the entity.

11. The non-transitory computer readable storage medium of claim 9, wherein the usage data is indicative of a number of times a dashboard associated with the application management system is accessed by the one or more users associated with the entity.

12. The non-transitory computer readable storage medium of claim 9, wherein generating the combined score includes:
determining a number of points to apply towards the combined score based on the usage data.

13. The non-transitory computer readable storage medium of claim 9, wherein the method further comprises:
identifying a second entity based on a similarity score with the entity;
comparing the adoption score to an adoption score associated with the second entity.

14. The non-transitory computer readable storage medium of claim 9, wherein one of the one or more subjective assessment scores represents a technical success of the application management system.

15. The non-transitory computer readable storage medium of claim 9, wherein the method further comprises:
predicting a drop in usage of the application management system by the one or more users associated with the entity.

16. The non-transitory computer readable storage medium of claim 9, wherein the method further comprises:
predicting an increase in usage of the application management system by the one or more users associated with the entity.

17. A server for determining the health of a network application customer, comprising:
a processor;
a memory; and
one or more modules stored in memory and executable by a processor to monitor, by one or more agents, usage of an application management system by one or more users associated with an entity, the one or more agents executing on one or more servers that implement the application management system; collect usage data regarding the monitored usage from the one or more agents; generate an adoption score for the entity based on the collected usage data; receive, from a user interface, one or more subjective assessment scores associated with the entity; generate a combined score for the entity based on the generated adoption score and the one or more subjective assessment scores; and provide the combined score for presentation by the user interface.

18. The system of claim 17, wherein the usage data is indicative of a number of logins to the application management system by the one or more users associated with the entity.

19. The system of claim 17, wherein the usage data is indicative of a number of times a dashboard associated with the application management system is accessed by the one or more users associated with the entity.

20. The system of claim 17, wherein the one or more modules are further executable to identify a second entity based on a similarity score with the entity and compare the adoption score to an adoption score associated with the second entity.
